(19) United States
(12) Patent Application Publication
(10) Pub. No.: US 2005/0220226 A1
(43) Pub. Date: Oct. 6, 2005

(54) Binary frequency-shift keying demodulator

(76) Inventors: Zhaofeng Zhang, Shanghai (CN); Jun Wu, Shanghai (CN); Guanghui Yang, Shanghai (CN)

Correspondence Address: LAW OFFICES OF CLEMENT CHENG, 17220 NEWHOPE STREET #127, FOUNTAIN VALLEY, CA, 92708, US

(21) Appl. No.: 10/850,753

(22) Filed: May 20, 2004

(30) Foreign Application Priority Data
Apr. 5, 2004 (CN) 200410017458.4

(51) Int. Cl. H04L 27/10

(52) U.S. Cl. 375/334

(57) ABSTRACT

A BFSK demodulator comprises a frequency-to-voltage converter, a differentiator circuit, and a sampling selector circuit. The frequency-to-voltage converter converts an information input signal into a voltage signal. The differentiator circuit receives the voltage signal and produces an input signal to the sampling selector circuit for reproducing a demodulated signal by properly selecting a plurality of reference voltage signals.

### TECHNICAL FIELD

The present invention relates to a wireless communication receiver device, and particularly relates to a binary frequency-shift keying demodulator.

### BACKGOUND OF THE INVENTION

Among wireless communication devices, the demodulator is often seen as one of the most important component in receiver end. Demodulators are utilized at the rear end of the receiver to demodulate the signal modulated from the front end, matching the initial information signal. Bit Error-Rate (BER) is the important key to rate such demodulators. Current Binary Frequency-Shift Keying (BFSK) signal demodulation methods can be categorized as coherent demodulation and incoherent demodulation, where the incoherent demodulation has lower resistance to noise. Among several coherent demodulation implementations, differential demodulator is easily structured and it also provides lower Bit Error-Rate. In addition, differential demodulator does not require local carrier wave, and it also demands lower precision of the resonator while it has lower phase error caused by the carrier signal. It is one of the most common demodulation methods, as it is referred in FIG. 1. However, the disadvantages of the differential demodulator are the larger circuit board design, which causes power consumption, and a necessary addition of an external phase-shifting circuit. Such large board and external circuit design is more affected by fabrication processes. Therefore under the circumstances when the information signal is similar to carrier signal, the demand on the filter is higher, such that a differential demodulator is not appropriate anymore.

### SUMMARY OF THE INVENTION

The present invention is to provide a BFSK demodulator that is without external support and has a simpler but more condensed circuit structure design. The present invention provides a BFSK demodulator comprising a frequency-to-voltage converter, a differentiator circuit and a sampling selector circuit, wherein a BFSK information signal passes through the frequency-to-voltage converter and becomes a voltage input into a differentiator circuit. The sampling selector circuit receives an output produced by the differentiator circuit and reproduces a demodulated signal after filtering possible noises.

The present invention does not require any external support elements. The present invention has a simpler, smaller circuit board design, and has a lower power consumption rate.

### BRIEF DESCRIPTION OF THE DRAWINGS

FIG. 1 is a block diagram of a prior art Binary Frequency-Shift Keying Demodulator

FIG. 2 is a block diagram of a Binary Frequency-Shift Keying Demodulator in present invention

FIG. 3 is a circuit illustration of a frequency-to-voltage converter in present invention

FIG. 4 is a circuit illustration of a differentiator circuit in present invention

FIG. 5 is a circuit illustration of a sampling selector circuit in present invention

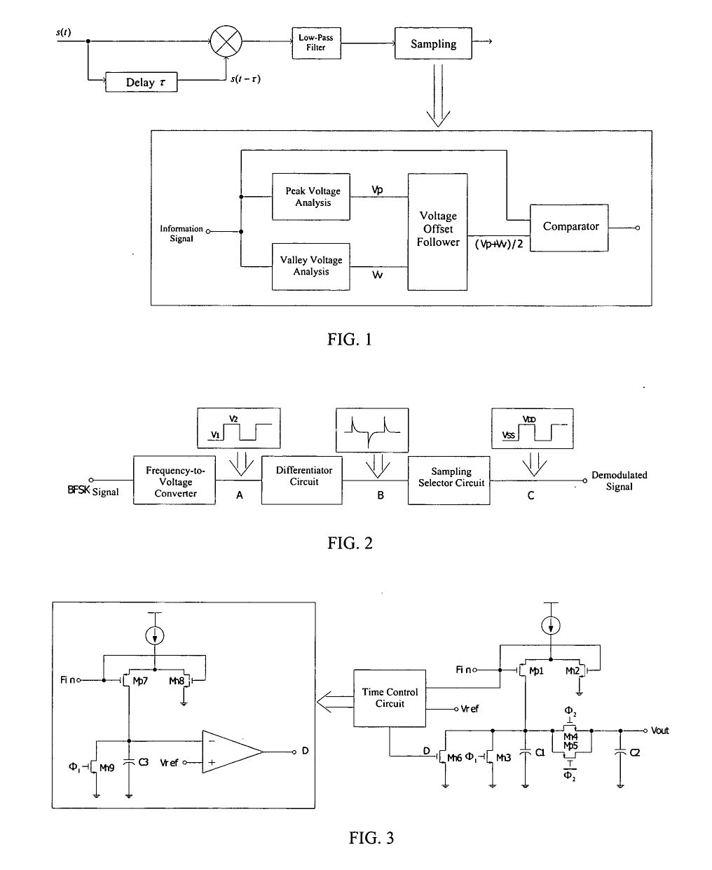

### DETAILED DESCRIPTION OF THE INVENTION

As is seen in FIG. 2, the present invention provides a Binary Frequency-Shift Keying Demodulator comprising a frequency-to-voltage converter, a differentiator circuit, and a sampling selector circuit. A BFSK signal is input to a frequency-voltage converter. A square wave output signal is produced by the frequency-voltage converter as shown on step A. Frequencies f_{c}+Δf and f_{c}−Δf (f_{c} is carrier wave frequency) match voltage V1 and V2, respectively (V₁<V₂). Since the voltage difference at step A may be too narrow to active a logic circuit to transform this demodulated signal at step A into digital, the signal at step A is differentiated by a differentiator circuit, having an output signal at step B. The signal at step B is filtered by a sampling selector circuit to produce a voltage signal output C. The signal at step C is the demodulated signal.

The output voltage wave from the frequency-to-voltage converter has various spikes from the discreteness caused by charge injection. When the wave passes through a differentiator, the spikes would be exposed along with rising and falling edges. Since the ΔV signal at BFSK is considerably high compared with the narrow amplitude at the spikes, the output from the differentiator is a series of pulse signals with small influence from the spikes. Through proper voltage limitation in sampling selector circuit, demodulated digital signals can be retrieved by filtering the pulse signals.

FIG. 3 illustrates a frequency-to-voltage converter adopted by the present Binary Frequency-Shift Keying Demodulator. When the input signal Fᵢₙ is LOW, transistors Mₚ₁ [symbol] Mₚ₇ are ON and transistor Mₙ₂ is OFF, while signals φ₁ [symbol] φ₂ are both LOW. Capacitor C₁ is being charged by Iᵢₙ and Capacitor C₃ is being charged by I_{c}. When the voltage on capacitor C₃ is lower than V_{ref}, D is HIGH turning transistor Mₙ₆ ON, voltage on capacitor C₁ is zero. When the voltage on capacitor C₃ is higher than V_{ref}, D is LOW, turning transistor Mₙ₆ OFF, voltage on capacitor C₁ is therefore rising. When the input signal Fᵢₙ is HIGH, transistors Mₚ₁ [symbol] Mₚ₇ are both OFF and transistor Mₙ₂ is ON, φ₂ turns HIGH first while φ₁ stays LOW, charges being rearranged on capacitors C₁ and C_{2.} Then φ₂ turns LOW, φ₁ turns HIGH, capacitors C₁ [symbol] C₃ start discharging until the voltage reach zero, and therefore φ₁ [symbol] φ₂ both turn back to LOW, until next signal period. The voltage on capacitor C₂ is referring to the voltage of the information frequency signal. It is well known that with a smaller capacitor C₂, more frequent capacitor C₁ charges, the voltage on capacitor C₂ is closer to the initial voltage on capacitor C₁. The purpose of adding a charging time control circuit here is to reduce the BER while operating at a better signal to noise ratios by enlarging the BFSK differential voltage Δ V under a limited source voltage. Transistor Mₚ₅ is implemented to reduce the charge injection effect caused from the ON/OFF actions of transistor Mₙ₄.

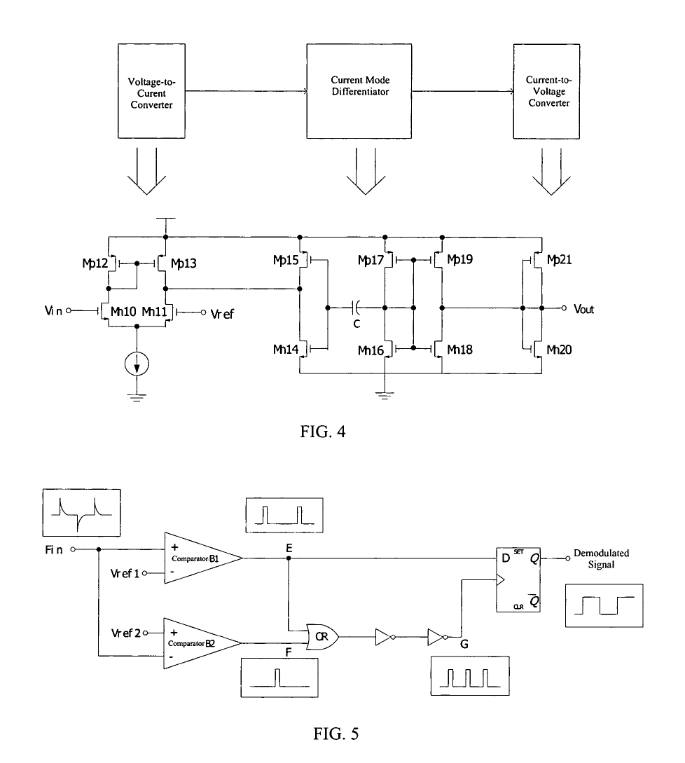

FIG. 4 illustrates the differentiator circuit adopted in the present invention. The differentiator comprises a voltage-to-current converter, a current mode differentiator, and a current-to-voltage converter.

The present invention adopts the current mode differentiator because a simple structured differentiator does not employ a traditional feedback circuit, and it not only has a lower power consumption rate, but also has a broader bandwidth.

The transmitting function of the differentiator circuit is as follows.

$$\frac{{i}_{out}}{{i}_{in}} = \frac{( {g}_{mp19} + {g}_{mn18} ) \cdot sC}{\begin{matrix}( {g}_{in} + {g}_{mn14} + {g}_{mp15} ) ( {g}_{mn16} + {g}_{mp17} ) + \\ ( {g}_{in} + {g}_{mn14} + {g}_{mp15} + {g}_{mn16} + {g}_{mp17} ) \cdot sC\end{matrix}}$$

gᵢₙ is the output admittance from the last level.

$$If s << \frac{( {g}_{in} + {g}_{mn14} + {g}_{mp15} ) ( {g}_{mn16} + {g}_{mp17} )}{( {g}_{in} + {g}_{mn14} + {g}_{mp15} + {g}_{mn16} + {g}_{mp17} ) \cdot C} , \\ \frac{{i}_{out}}{{i}_{in}} = \frac{( {g}_{mp19} + {g}_{mn18} ) \cdot sC}{( {g}_{in} + {g}_{mn14} + {g}_{mp15} ) ( {g}_{mn16} + {g}_{mp17} )}$$

Since the output from the frequency-to-voltage converter is a voltage signal, a converting process conducted by a voltage-to-current converter is necessary to produce a current signal input to the current mode differentiator, as it is designed at the first level in the present differentiator circuit. It is therefore needed a current-to-voltage converter to convert the current output from the differentiator into a voltage signal.

FIG. 5. illustrates a sampling selector circuit. The output from the differentiator is a pulse signal, as shown on FIG. 2, and the output signal is passed into first and second comparator B₁ and B₂ respectively. The reference voltage of comparator B1 is V_{ref1}. The reference voltage of comparator is V_{ref2}. When the portion of pulse signal Fᵢₙ is higher than V_{ref1}, the output at point E produces a square wave signal from the comparator B1; when the portion of pulse signal Fᵢₙ is lower than V_{ref2}, the output at point F also produces a square wave signal from the comparator B2. Combining signals from point E and F produces a clock signal at point G. A D flip-flop therefore produces a demodulated signal output by sampling the output at point E and the clock signal at point G.

Properly selecting reference voltage V_{ref1} and V_{ref2} can filter out numerous high frequency noises, especially the discreteness caused by the charge injection effect from the frequency-to-voltage converter.

1. A BFSK demodulator comprising a frequency-to-voltage converter, a differentiator circuit, and a sampling selector circuit, wherein the frequency-to-voltage converter converts an information input signal into a voltage signal, the differentiator circuit receiving the voltage signal and producing an input signal to the sampling selector circuit for reproducing a demodulated signal by properly selecting a plurality of reference voltage signals.

2. The demodulator of claim 1, wherein the differentiator circuit further comprises a voltage-to-current converter, a current-mode differentiator, and a current-to-voltage converter, the voltage signal input is converted into current signal by the voltage-to-current converter before being differentiated by the current-mode differentiator, an output from the current-mode differentiator is converted into a voltage signal by the current-to-voltage converter.

3. The demodulator of claim 1, wherein the sampling selector circuit further comprises first and second comparators, an OR gate, first and second converters, and a D filp-flop, the first and second comparators receiving a pulse voltage signal from the differentiator circuit respectively, the first comparator having a first reference voltage input and the second comparator having a second reference voltage input, the first comparator producing a first pulse voltage output after comparing the pulse voltage with the first reference voltage signal, the second comparator producing a second pulse voltage signal after comparing the pulse signal with the second reference voltage signal, the OR gate combining the first and second pulse voltage outputs and producing a clock signal for the D filp-flop after passing through the first and second converters, the D flip-flop producing a demodulated output digital signal.

4. A BFSK demodulator comprising a frequency-to-voltage converter, a differentiator circuit, and a sampling selector circuit, wherein the frequency-to-voltage converter converts a BFSK frequency signal to a voltage signal, the differentiator circuit receiving the voltage signal and producing a pulse signal; the sampling selector receiving the pulse signal and filtering it to form a demodulated BFSK signal output.

5. The demodulator of claim 4, wherein the differentiator circuit further comprises a voltage-to-current converter, a current-mode differentiator, and a current-to-voltage converter, the voltage signal input is converted into current signal by the voltage-to-current converter before being differentiated by the current-mode differentiator, an output from the current-mode differentiator is converted into a voltage signal by the current-to-voltage converter.

6. The demodulator of claim 4, wherein the sampling selector circuit further comprises first and second comparators, an OR gate, first and second converters, and a D filp-flop, the first and second comparators receiving a pulse voltage signal from the differentiator circuit respectively, the first comparator having a first reference voltage input and the second comparator having a second reference voltage input, the first comparator producing a first pulse voltage output after comparing the pulse voltage with the first reference voltage signal, the second comparator producing a second pulse voltage signal after comparing the pulse signal with the second reference voltage signal, the OR gate combining the first and second pulse voltage outputs and producing a clock signal for the D filp-flop after passing through the first and second converters, the D flip-flop producing a demodulated output digital signal.

7. A method of producing a BFSK demodulated signal comprising the steps of:
(a) converting a BFSK frequency signal to a voltage signal;
b) differentiating the voltage signal to a pulse signal through a differentiator circuit;
(c) producing a demodulated signal by filtering the pulse signal by a sampling selector circuit.

8. The method of producing a BFSK demodulated signal of claim 7, wherein step (b) further comprises the steps of:
(a) converting a voltage signal to a current signal;
(b) differentiating the voltage signal to a pulse signal through a current mode differentiator circuit producing an output signal;
(c) converting the output signal to a voltage signal.

9. The method of producing a BFSK demodulated signal of claim 7, wherein the sampling selector circuit further comprises first and second comparators, an OR gate, first and second converters, and a D filp-flop, the first and second comparators receiving a pulse voltage signal from the differentiator circuit respectively, the first comparator having a first reference voltage input and the second comparator having a second reference voltage input, the first comparator producing a first pulse voltage output after comparing the pulse voltage with the first reference voltage signal, the second comparator producing a second pulse voltage signal after comparing the pulse signal with the second reference voltage signal, the OR gate combining the first and second pulse voltage outputs and producing a clock signal for the D filp-flop after passing through the first and second converters, the D flip-flop producing a demodulated output digital signal.
